(19) United States
(12) Patent Application Publication
(10) Pub. No.: US 2025/0298198 A1
(43) Pub. Date: Sep. 25, 2025

(54) OPTICAL CONNECTORS AND METHODS OF ASSEMBLING THE SAME

(71) Applicant: MELLANOX TECHNOLOGIES, LTD., Yokneam (IL)

(72) Inventors: Barak FREEDMAN, Binyamina (IL); Amit OREN, Ramat Hasharon (IL)

(73) Assignee: MELLANOX TECHNOLOGIES, LTD., Yokneam (IL)

(21) Appl. No.: 18/889,952

(22) Filed: Sep. 19, 2024

Related U.S. Application Data
(60) Provisional application No. 63/569,316, filed on Mar. 25, 2024.

(51) Int. Cl. G02B 6/42

(52) U.S. Cl. CPC G02B 6/4227; G02B 6/4225; G02B 6/4232; G02B 6/428

(57) ABSTRACT

Some embodiments of the present disclosure are directed to optical connectors and methods of assembling the same. For example, the present disclosure provides for a “semi-detachable” connector. A mechanical receptacle may be actively aligned to the photonic integrated circuit die, allowing for full testing of the device and for a simplified assembly process. At a later step in the assembly process, the connector may be placed on the receptacle (passively—already tested) and the connector may be adhered to the receptacle. The present disclosure may result in a simplified assembly, and a smaller device size that fits inside an octal small form factor pluggable (OSFP) transceiver.

### CROSS-REFERENCE TO RELATED APPLICATION

The present application claims the benefit of U.S. Patent Application No. 63/569,316 for “Silicon Photonics Connectors and Methods of Assembling the Same” filed Mar. 25, 2024, which is hereby incorporated by reference in its entirety.

### TECHNOLOGICAL FIELD

The present disclosure is directed to optical connectors and methods of assembling the same.

### BACKGROUND

With demand for high-speed and high-volume data communication increasing, communications providers are increasingly adopting optics-based communication solutions. To meet these demands, methods of improving the manufacturing of optical elements are being developed.

### GENERAL DESCRIPTION

In one aspect, the present disclosure is directed to a method of assembling a connector for a photonic integrated circuit (IC), the method may include actively aligning an optical path window of a receptacle with an optical window of a photonic IC while transmitting optical signals through a first connector and the receptacle and testing the optical signals, securing the receptacle to the photonic IC using a first adhesive, and securing a second connector to the receptacle using a second adhesive while the photonic IC is mechanically connected to a product printed circuit board.

In some embodiments, the method may include, after securing the receptacle to the photonic IC using the first adhesive and before securing the second connector to the receptacle, performing a flip-chip and reflow process on the photonic IC to mechanically and electrically connect the photonic IC to a package substrate. Further, the method may include, after performing the flip-chip and reflow process, performing a ball-grid-array reflow process to mechanically and electrically connect the package substrate to the product printed circuit board.

In another aspect, the present disclosure is directed to an electronic module, which may include a receptacle including an optical path window, where the receptacle may be secured to a photonic integrated circuit (IC) having an optical window using an adhesive, and where the optical path window may be actively aligned with the optical window. Further, the electronic module may include a connector secured to the receptacle. Additionally, or alternatively, the optical path window may include adhesive bleeding stoppers configured to prevent adhesive from entering the optical path.

In some embodiments, the receptacle may include one or more alignment features for aligning the connector with the photonic IC. Further, the receptacle may include one or more alignment features for aligning the receptacle with the photonic IC. Additionally, or alternatively, the receptacle may include one or more alignment features for aligning the receptacle with the connector.

In another aspect, the present disclosure is directed to a method of assembling a connector for a photonic integrated circuit, the method may include actively aligning an optical path window of a receptacle with an optical window of a photonic integrated circuit (IC) while transmitting optical signals through a first connector and the receptacle and testing the optical signals, securing the receptacle to the photonic IC using a first adhesive, and securing a connector surface of a second connector to a receptacle surface of the receptacle by positioning a material between the connector surface and the receptacle surface while the photonic IC is mechanically connected to a product printed circuit board.

In some embodiments, the method may include, after securing the receptacle to the photonic IC using the first adhesive and before securing the second connector to the receptacle, performing a flip-chip and reflow process on the photonic IC to mechanically and electrically connect the photonic IC to a package substrate. Further, the method may include, after performing the flip-chip and reflow process, performing a ball-grid-array reflow process to mechanically and electrically connect the package substrate to the product printed circuit board. Additionally, or alternatively, the method may include, after performing the flip-chip and reflow process, testing optical performance and electrical performance of the photonic integrated circuit.

In another aspect, the present disclosure is directed to an optical device that may include a photonic integrated circuit (IC) including a first photonic IC surface and a second photonic IC surface, an adhesive layer disposed on a region of the second photonic IC surface, a receptacle including a first receptacle surface and a second receptacle surface, where the first receptacle surface may be disposed on the region of the second photonic IC surface including the adhesive layer and where the first receptacle surface may be adhered to the second photonic IC surface, and a connector including a first connector surface and a second connector surface, where the first connector surface may be disposed on the second receptacle surface, where a material may be disposed between the first connector surface and the second receptacle surface such that the first connector surface may be adhered to the second receptacle surface.

In some embodiments, the first photonic IC surface may be disposed on a second surface of a package substrate. Further, a first surface of the package substrate may be mechanically and electrically connected to a printed circuit board. Additionally, or alternatively, the photonic IC may include an optical window, and the receptacle may include an optical path window.

In some embodiments, the optical path window and the optical window are actively aligned. Further, the receptacle may include a plurality of alignment features.

The features, functions, and advantages that have been discussed may be achieved independently in various embodiments of the present disclosure or may be combined with yet other embodiments, further details of which may be seen with reference to the following description and drawings.

### BRIEF DESCRIPTION OF THE DRAWINGS

Having thus described embodiments of the disclosure in general terms, reference will now be made to the accompanying drawings, wherein:

FIG. 1 is a schematic, partially exploded, perspective view of an electronic module;

FIG. 2A schematically depicts a method for manufacturing an electronic module;

FIG. 2B schematically depicts another method of manufacturing an electronic module;

FIG. 3 depicts an electronic module, in accordance with an embodiment of the present disclosure;

FIG. 4 depicts an optical device, in accordance with an embodiment of the present disclosure;

FIG. 5 schematically depicts a method for manufacturing an optical module, in accordance with an embodiment of the present disclosure;

FIG. 6 is a flowchart illustrating a method of assembling a connector for a photonic integrated circuit, in accordance with an embodiment of the present disclosure;

FIG. 7 is a flowchart illustrating a method of assembling a connector for a photonic integrated circuit, in accordance with an embodiment of the present disclosure;

FIGS. 8A and 8B illustrate a cross-sectional view and a top plan view, respectively, of an optoelectronic component, in accordance with an embodiment of the present disclosure;

FIG. 9 illustrates a portion of an example optoelectronic component, in accordance with an embodiment of the present disclosure;

FIG. 10 illustrates another example optoelectronic component, in accordance with an embodiment of the present disclosure; and

FIG. 11 illustrates an MCM assembly, in accordance with an embodiment of the present disclosure.

### DETAILED DESCRIPTION OF EMBODIMENTS

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Furthermore, when it is said herein that something is “based on” something else, it may be based on one or more other things as well. In other words, unless expressly indicated otherwise, as used herein “based on” means “based at least in part on” or “based at least partially on.” Also, as used herein, the term “or” is intended to be inclusive when used in a series and may be used interchangeably with “and/or,” unless explicitly stated otherwise (e.g., if used in combination with “either” or “only one of”). Like numbers refer to like elements throughout. No element, act, or instruction used herein should be construed as critical or essential unless explicitly described as such.

The present disclosure is directed to optical connectors and methods of assembling the same. Optical connectors (e.g., an optical element that may be attached to a photonic IC and may receive an optical fiber such that optical inputs and/or outputs can be transmitted to and/or from the photonic IC via the connector) have a pivotal role in co-packaged optics (CPO) packages. A CPO package may integrate photonic high-speed optical interconnect components with functional switch application-specific integrated circuits (ASICs) or graphics processing units (GPUs a central processing unit (CPU), a data processing unit (DPU), microprocessors, FPGAs, combinations thereof, a collection of logic gates or transistors, resistors, capacitors, inductors, diodes, a switch (e.g., a high-speed network switch), a network adapter, a CPU, a memory device, an input/output (I/O) device, other peripheral devices or components on a system-on-chip (SoC), or other devices and components at which a signal is received or measured, Integrated Circuit (IC) chip, etc. and/or the like) on a common substrate. By using CPO systems, computing systems may significantly reduce cost and power consumption over current systems. Current methods of manufacturing CPO packages involve optical elements that require active alignment (e.g., a process of receiving optical feedback for alignment by positioning optical elements, as optical devices are being assembled, to ensure precision and/or accuracy of optical signal transmission) in order to transmit the optical signal properly. In a traditional CPO package, an optical signal may be transmitted via optical fibers to a connector that may be either fixed (e.g., connected by adhesive) or fully detachable (e.g., connected by a clip) to a photonic die. The fixed case results in a very complex assembly flow, high yield loss due to an attached fiber, requires a higher cost of manufacturing, and does not allow for chip-scale optical package (CSOP) pre-assembly tests. Additionally, in the fully detachable case, a receptacle (e.g., a mechanical device that may be aligned to a chip such that an optical connector received by the mechanical device may be aligned to the chip) may be first aligned and then attached to the photonic die via a clip which increases the connector's overall height such that a CPO package is too big to fit inside an octal small form factor pluggable (OSFP) transceiver and increases the optical path for the optical signal. In other words, using a fixed connector attachment results in a complex assembly flow and high yield loss due to an attached optical fiber. A fully detachable connector remedies these problems; however, the resulting assembly may be too large to fit inside an OSFP transceiver.

The present disclosure provides for a “semi-detachable” connector. A mechanical receptacle may be actively aligned to the photonic die, allowing for full testing of the device and for a simplified assembly process. At a later step in the assembly process, the connector may be placed on the receptacle (passively-already tested) and the connector may be adhered to the receptacle. The present disclosure may result in a simplified assembly, and a smaller device size that fits inside the OSFP transceiver.

The technique of this disclosure removes the need for complex and expensive active alignment processes during the manufacturing of optical transceivers. In some embodiments, a photonic die may be provided, where the die may include an adhesive layer on a portion of a top surface of the die. Further, a mechanical receptacle may be provided, where the mechanical receptacle may be optically aligned to the die. The mechanical receptacle enables alignment of an optical connector to the die. In some embodiments, the mechanical receptacle may be disposed on the adhesive layer on the portion of the top surface of a die once optically aligned, adhering the mechanical receptacle to the die. Such assembly steps may allow for full testing of the device (e.g., transmitting optical signals to the photonic IC via a connector to ensure precise and/or accurate transmission of the optical signal prior to assembly into a package) and for a simplified assembly process. In some embodiments, a second adhesive layer may be provided and disposed on a top surface of the mechanical receptacle. Further, a semi-detachable connector may be disposed on top of the die—mechanical receptacle—second adhesive layer stack and the semi-detachable connector may be adhered to the stack via the second adhesive layer. The semi-detachable connector of the present disclosure may result in a simplified assembly and a smaller device size that may fit inside an octal small form factor pluggable (OSFP) transceiver.

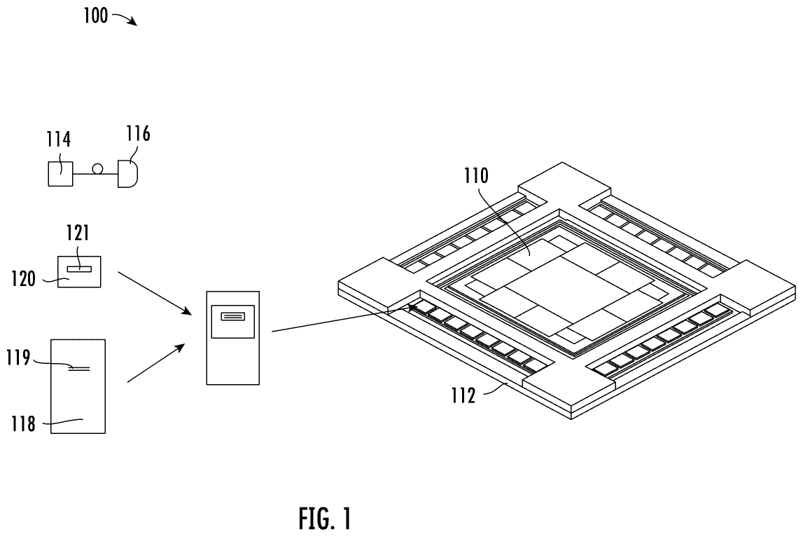

FIG. 1 is a schematic, partially exploded, perspective view of an electronic module 100 (e.g., an electronic device, a CPO package, a chip-on-wafer device, a silicon photonic IC, a photonic wafer, and/or the like). As shown in FIG. 1, the electronic module 100 may include a substrate 112, a chip-on-wafer 110 (e.g., a main dic), and a plurality of dies 118 (e.g., photonic integrated circuits (ICs), such as silicon photonic chips, and/or the like). Photonic integrated circuits (PICs) are a current area of investigation for a variety of applications. For example, various types of PICs have applications in fiber-optic communications, the biomedical field, photonic computing, autonomous vehicles, and other fields. In various circumstances, PICs may be formed and/or fabricated as SiP on and/or as part of a SiP chip. Various fiber-optic communications applications, for example, require an optical signal from a PIC waveguide (e.g., a waveguide formed on and/or as part of a SiP chip) to be passed to an external optical fiber or for an optical signal to be passed from an external optical fiber to a PIC waveguide (e.g., a waveguide formed on and/or as part of a SiP chip). For example, an optical fiber may be used to provide an optical signal from an external source or may be used to provide an optical signal from the PIC to an external receiver. Thus, efficient methods for coupling and/or efficient coupling devices are needed for coupling external optical fibers to PICs and/or SiP chips. As also shown in FIG. 1, the chip-on-wafer 110 may be positioned on a central portion of the substrate 112, and the plurality of dies 118 may be positioned on a peripheral portion of the substrate 112. As will be appreciated by those of ordinary skill in the art in view of this disclosure, a representative die 118 is depicted on the left side of FIG. 1 as being representative of the dies 118 on the peripheral portion of the substrate 112.

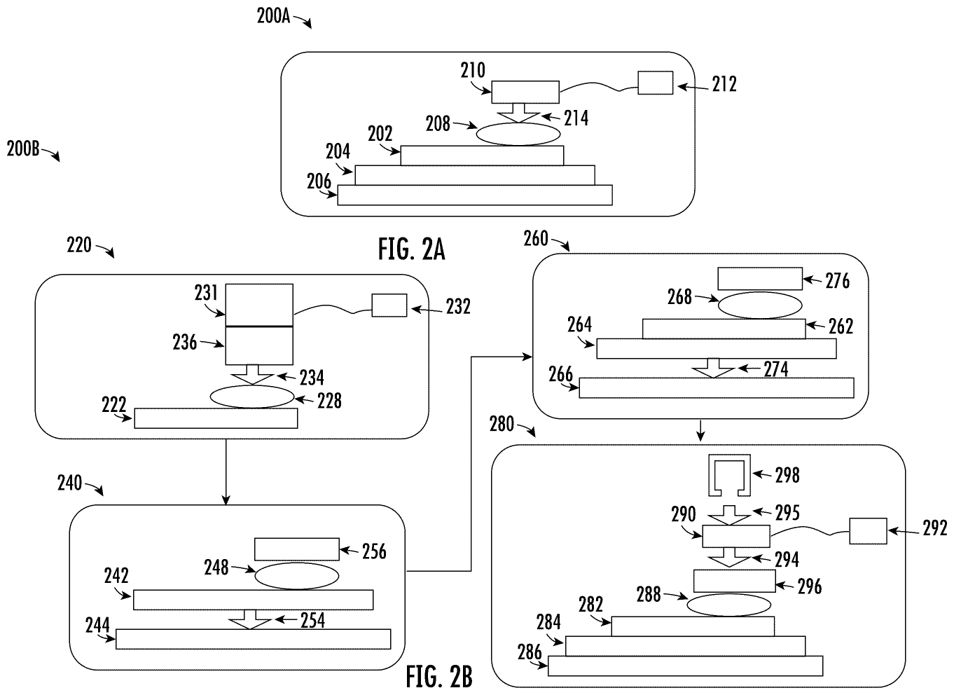

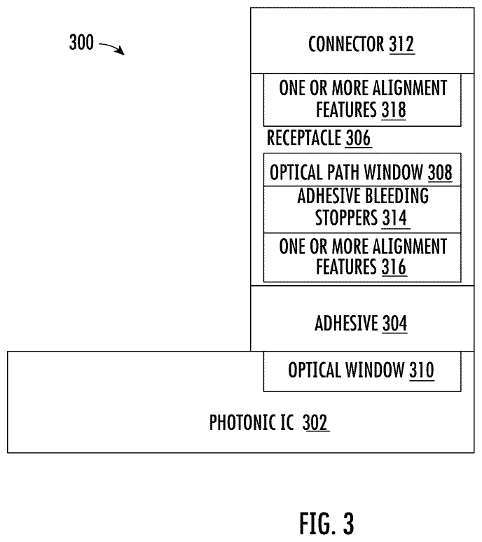

As shown in FIG. 1, a receptacle 120 (e.g., similar to a receptacle 236 shown and described herein with respect to FIG. 2) including an optical path window 121 may be positioned on each of the dies 118, and each receptacle 120 may be configured to align its optical path window 121 and a corresponding connector 114 with an optical window 119 (e.g., an opening that may allow for receiving and/or transmitting optical signals between optical elements) of a corresponding die 118. In some embodiments, the receptacle 120 may be bonded and actively aligned to the die 118 to form a die with receptacle stack during a method of manufacturing shown and described herein with respect to FIG. 3. The detachable connectors 114 may be connected via optical fibers to an optical connector 116 (e.g., a multi-fiber push on (MPO) connector and/or the like), which are in optical communication with one or more optical devices (not pictured). In some embodiments, multi-fiber optical connectors may be used (e.g., Multi-fiber Push On (MPO)) to combine, on the same optical connector fibers coming from chiplets (carrying data), with fibers coming from an optical switch. In this way, the receptacles 120 and the detachable connectors 114 optically connect the dies 118 of the electronic module 100 to one or more optical devices Further, at PCBA (printed circuit board assembly) level a simple mechanical assembly of the fiber ribbon may be provided, being self-aligned to the receptacle.

In some embodiments, one or more of the dies 118 may be configured to receive electrical signals from the chip-on-wafer 110 (e.g., via electrical traces through the substrate 112), convert the electrical signals to optical signals, and transmit the optical signals to one or more optical devices. Additionally, or alternatively, one or more of the dies 118 may be configured to receive optical signals from one or more optical devices, convert the optical signals to electrical signals, and transmit the electrical signals to the chip-on-wafer 110 (e.g., via electrical traces through the substrate 112).

FIG. 2A schematically depicts a method 200A for manufacturing an electronic module. As shown in FIG. 2A, the electronic device may include a product printed circuit board (PCB) 206 (e.g., a device PCB, a system PCB, a switch PCB, and/or the like), a package substrate 204 (e.g., a chip-scale optical package (CSOP) and/or the like), a photonic IC 202 (e.g., a silicon-photonic chip), and a connector 210 connected via optical fibers to an MPO connector 212.

As shown in FIG. 2A, the method 200A may include a step 214 of securing the connector 210 directly to the photonic IC 202 using an adhesive 208 (e.g., UV-cured and/or thermal cured adhesives). In some embodiments, the method 200A may include actively aligning the connector 210 with the photonic IC 202. In this regard, the method 200A may include applying an adhesive 208 to a surface of the photonic IC 202 and/or a surface of the connector 210. The method 200A may further include actively aligning the connector 210 with an optical window of the photonic IC 202 while transmitting optical signals through the connector 210 and testing the optical signals. The method 200A may include actively changing the position of the connector 210 on the photonic IC 202 to determine an optimal alignment of the connector 210 with respect to the photonic IC 202 that ensures complete and/or near-complete transmission of the optical signals through the connector 210. The method 200A may include, upon determining an optimal alignment, curing the adhesive 208 to permanently adhere the connector 210 to the photonic IC 202.

Such a method achieves a low overall device height; however, the method does not permit testing of the package substrate 204 before assembly of the electronic module. Furthermore, performing active alignment this late in the assembly process requires accuracy at a stage in the device assembly process where assembly accuracy is conventionally not required, which increases the likelihood of an assembly error. Additionally, if the connector 210 is secured to the photonic IC 202 and is misaligned with respect to the optical window of the photonic IC 202, the entire device (e.g., the product PCB, the CSOP package, the photonic IC, and the connector) must be discarded such that the assembly method has a high yield cost.

FIG. 2B schematically depicts another method 200B of manufacturing an electronic module. As shown in FIG. 2B, the method 200B may include a step 220 of actively aligning a receptacle 236 with a photonic IC 222. In this regard, the method 200B may include applying an adhesive 228 to a surface of the photonic IC 222 and/or a surface of the receptacle 236 and connecting a golden connector 231 (e.g., a test connector) to the receptacle 236. The method 200B may further include actively aligning the optical path window with an optical window of the photonic IC 222 while transmitting optical signals through the golden connector 231 and the receptacle 236 and testing the optical signals. The method 200B may include actively changing the position of the receptacle 236 on the photonic IC 222 to determine an optimal alignment of the receptacle 236 with respect to the photonic IC 222 that ensures complete and/or near-complete transmission of the optical signals through the golden connector 231 and the receptacle 236. The method 200B may include, upon determining an optimal alignment, curing the adhesive 228 to permanently adhere the receptacle 236 to the photonic IC 222.

As shown in FIG. 2B, the method 200B may include performing a flip-chip and reflow process 240 (e.g., a method for connecting chips to external circuit components via solder bumps that may be subjected to external heat to form solder joints to permanently attach the chips to external circuit components) on a photonic IC 242 to mechanically and electrically connect the photonic IC 242 to a package substrate 244. As also shown in FIG. 2B, the method 200B may include performing a ball-grid-array (BGA) reflow process 260 (e.g., surface mount packaging using an array of solder balls) to mechanically and electrically connect a package substrate 264 to a product printed circuit board (PCB) 266 (e.g., a device PCB, a system PCB, a switch PCB, and/or the like).

As shown in FIG. 2B, the method 200B may include a step 280 of positioning a connector 290 on a receptacle 296 and securing a connector 290 to the receptacle 296 using a clip 298. Due to corresponding alignment features of the connector 290 and the receptacle 296 (e.g., features that protrude away from and/or extend into a respective clement such that these features may interconnect with features that protrude away from and/or extend into another respective clement), the connector 290 aligns itself with the receptacle 296 such that the optical path window of the receptacle 296 properly aligns the optical path with the connector 290.

However, the combined height of the clip and the connector 290 must be accounted for in the overall device design. Furthermore, such a height is unsuitable for octal small form pluggable (OSFP) transceivers.

FIG. 3 depicts an electronic module 300, in accordance with an embodiment of the present disclosure. In some embodiments, the electronic module 300 may include a receptacle 306 including an optical path window 308. Further, the receptacle 306 may be secured to a photonic IC 302 using an adhesive 304. Additionally, or alternatively, the photonic IC 302 may have an optical window 310 and the optical path window 308 may actively aligned with the optical window 310. In some embodiments, a connector 312 may be secured (e.g., anchored, secured via an adhesive, solder, sockets, mechanical support or braces, support brackets, screws, fasteners, bolts, retainers, a clip, and/or the like) to the receptacle 306.

In some embodiments, the optical path window 308 may include adhesive bleeding stoppers 314 configured to prevent adhesive 304 from entering the optical path. Further, the receptacle 306 may include one or more alignment features 316 and 318 for aligning the connector 312 with the photonic IC 302. Additionally, or alternatively, the receptacle 306 may include one or more alignment features 316 for aligning the receptacle 306 with the photonic IC 302. In some embodiments, the receptacle may include one or more alignment features for 318 aligning the receptacle 306 with the connector 312.

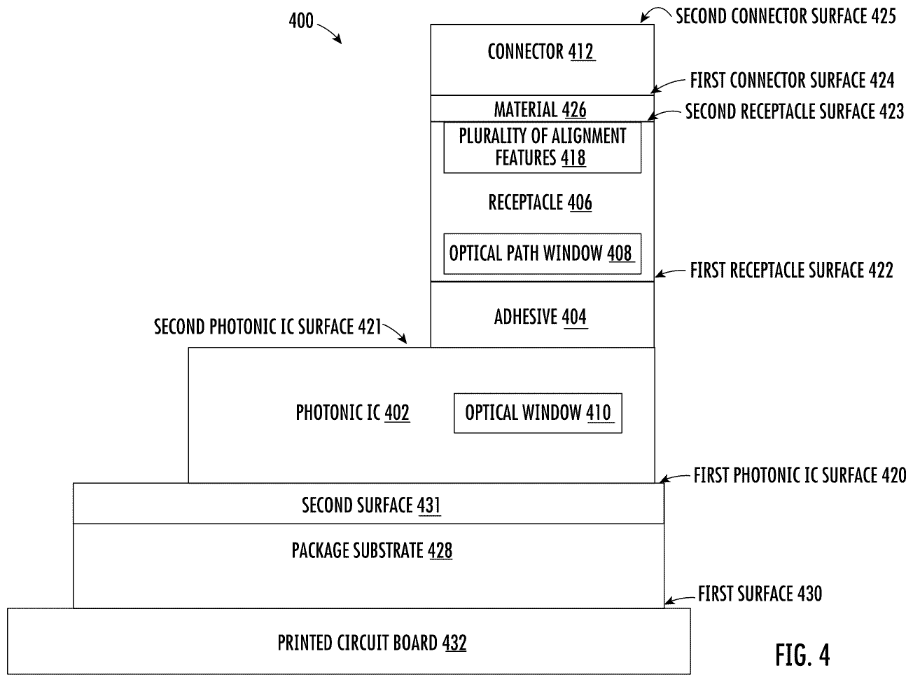

FIG. 4 depicts an optical device 400, in accordance with an embodiment of the present disclosure. In some embodiments, the optical device 400 may include a photonic IC 402 including a first photonic IC surface 420 and a second photonic IC surface 421. Further, the optical device 400 may include an adhesive layer 404 disposed on a region of the second photonic IC surface 421. Additionally, or alternatively, the optical device 400 may include a receptacle 406 including a first receptacle surface 422 and a second receptacle surface 423, where the first receptacle surface 422 is disposed on the region of the second photonic IC surface 421 including the adhesive layer 404, and where the first receptacle surface 422 may be adhered to the second photonic IC surface 421. In some embodiments, the optical device 400 may include a connector 412 comprising a first connector surface 424 and a second connector surface 425, where the first connector surface 424 is disposed on the second receptacle surface 423 and an adhesive material 426 (e.g., a substance that holds two surfaces together) may be disposed between the first connector surface 424 and the second receptacle surface 423 such that the first connector surface 424 is adhered to the second receptacle surface 423.

In some embodiments, the first photonic IC surface 420 may be disposed on a second surface 431 of a package substrate 428. Further, a first surface 430 of the package substrate 428 may be mechanically and electrically connected to a printed circuit board 432. Additionally, or alternatively, the photonic IC 402 may include an optical window 410, and the receptacle 406 comprises an optical path window 408.

In some embodiments, the optical path window 408 and the optical window 410 may be actively aligned. Further, the receptacle 406 may include a plurality of alignment features 418.

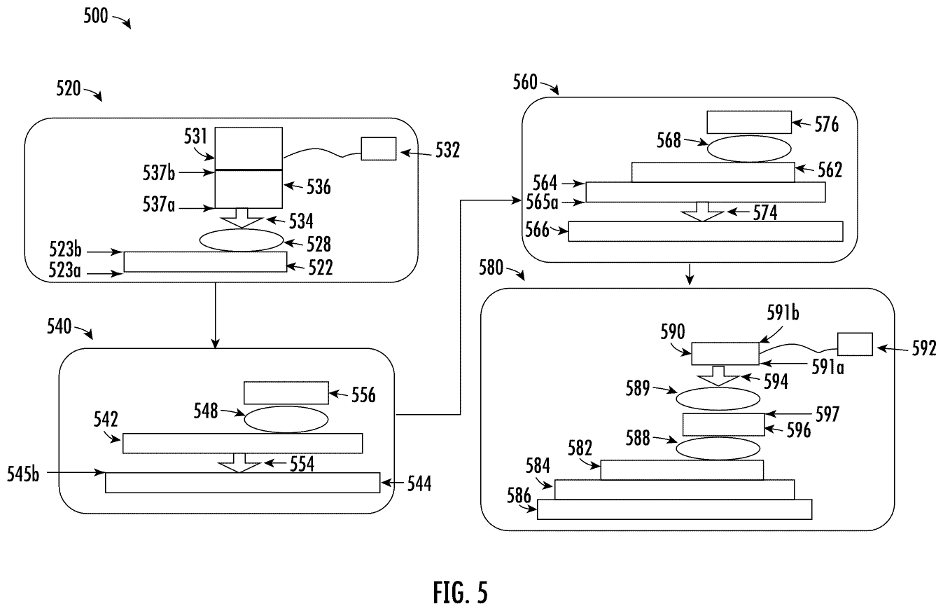

Some embodiments of the present disclosure are directed to an optical device, a method for manufacturing an optical device, and/or the like in which a connector is secured to a receptacle on a photonic IC using adhesive. For example, FIG. 5 schematically depicts a method 500 for manufacturing an optical device, in accordance with an embodiment of the present disclosure.

As shown in FIG. 5, the method 500 may include a step 520 of actively aligning a receptacle 536 with a photonic IC 522. In this regard, the method 500 may include applying an adhesive 528 to a second photonic IC surface 523b of the photonic IC 522 and/or a first receptacle surface 537a of the receptacle 536 and connecting a golden connector 531 (e.g., a test connector) to a second receptacle surface 537b of the receptacle 536. The method 500 may further include actively aligning the optical path window with an optical window of the photonic IC 522 while transmitting optical signals through the golden connector 531 and the receptacle 536 and testing the optical signals (e.g., transmitting optical signals to the photonic IC via a connector during the active alignment process to ensure precise and/or accurate transmission of the optical signal) for optical performance. The method 500 may include actively changing the position of the receptacle 536 on the photonic IC 522 to determine an optimal alignment of the receptacle 536 with respect to the photonic IC 522 that ensures complete and/or near-complete transmission of the optical signals through the golden connector 531 and the receptacle 536. The method 500 may include, upon determining an optimal alignment, curing the adhesive 528 to permanently adhere the receptacle 536 to the photonic IC 522. In some embodiments, the receptacle 536 may include adhesive bleeding stoppers configured to prevent the adhesive 528 securing the receptacle 536 to the photonic IC 522 from entering the optical path.

As shown in FIG. 5, the method 500 may include performing a flip-chip and reflow process 540 on a photonic IC 542 to mechanically and electrically connect a photonic IC surface (e.g., a first photonic IC surface 523a) of the photonic IC 542 to a second surface 545b of a package substrate 544 (e.g., a chip-scale optical package (CSOP) and/or the like). As also shown in FIG. 5, the method 500 may include performing a ball-grid-array (BGA) reflow process 560 to mechanically and electrically connect a first surface 565a of a package substrate 564 to a product printed circuit board (PCB) 566 (e.g., a device PCB, a system PCB, a switch PCB, and/or the like).

As shown in FIG. 5, the method 500 may include a step 580 of positioning a connector 590 on a receptacle 596 and securing the connector 590 to the receptacle 596 by using adhesive 589 disposed between a first connector surface 591a and a second receptacle surface 597. Due to corresponding alignment features of the connector 590 and the receptacle 596, the connector 590 aligns itself with the receptacle 596 such that the optical path window of the receptacle 596 properly aligns the optical path with the connector 590. In some embodiments, the receptacle 596 may include adhesive bleeding stoppers configured to prevent the adhesive 589 securing the connector 590 to the receptacle 596 from entering the optical path. Additionally, or alternatively, the connector 590 may be configured to receive and/or transmit signals via an MPO 592 attached to the connector between the first connector surface 591a and a second connector surface 591b.

By using the connector 590 that is detachable from the receptacle 596, the active alignment of the receptacle 596 with respect to the optical window of the photonic IC 582 may be performed and tested before the photonic IC 582 is mechanically connected to the package substrate 584 and/or the product PCB 586, that is, at the die level of assembly, rather than the device level of assembly. Being able to test the alignment at the die level allows for misalignments to be detected early in the assembly process such that, if misaligned, only the photonic IC 582 and the receptacle 596 are disposed of, rather than the entire device (e.g., including the package substrate, the product PCB, and/or the like).

Furthermore, such methods permit testing of the package substrate 584 before assembly of the electronic module. Performing active alignment early in the assembly process eliminates the need for accurate assembly at a stage in the device assembly process where assembly accuracy is conventionally not required, which reduces the likelihood of an assembly error. Additionally, the height of such a package is suitable for OSFP transceivers.

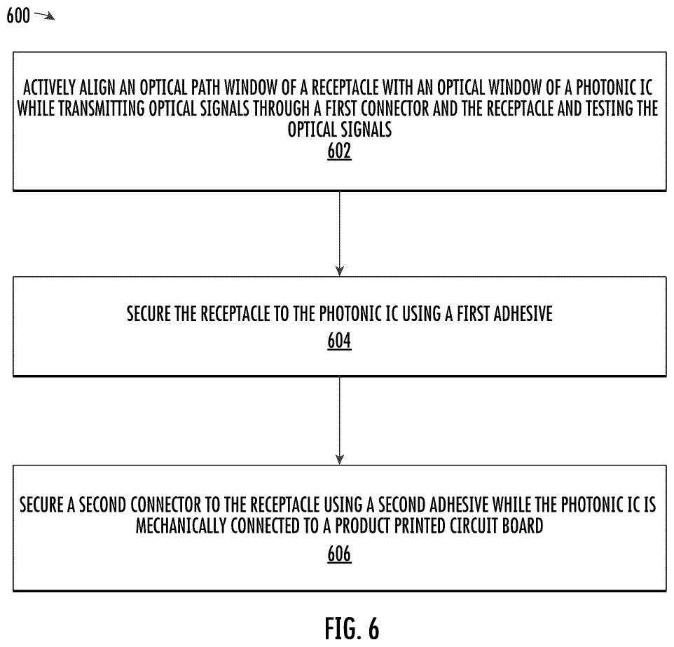

FIG. 6 is a flowchart illustrating a method 600 of assembling a connector for a photonic integrated circuit, in accordance with an embodiment of the disclosure. In some embodiments, the method 600 and/or steps described herein with respect to the method 600 may be performed in conjunction with and/or as one or more steps of the method 500 described herein with respect to FIG. 5.

As shown in block 602, the method 600 may include actively aligning an optical path window of a receptacle with an optical window of a photonic IC while transmitting optical signals through a first connector and the receptacle and testing the optical signals (e.g., similar to step 520 as shown and described herein with respect to FIG. 5). In some embodiments, actively aligning an optical path window of a receptacle with an optical window of a photonic IC may cause optical signals to be accurately transmitted through an electronic device. Further, the first connector may include an optical fiber and an MPO transmitting an optical signal to the first connector. In some embodiments, the receptacle, the photonic IC, and the first connector may be similar to the receptacle, the photonic IC, and the golden connector as shown and described herein with respect to FIG. 5.

As shown in block 604, the method 600 may include securing the receptacle to the photonic IC using a first adhesive. For example, after actively aligning the optical path window of the receptacle with the optical window of the photonic IC, the method 600 may include securing the receptacle to the photonic IC using an adhesive such that the receptacle may be held fixed with respect to the photonic IC. In some embodiments, the optical path window of the receptacle may remain optically aligned with the optical window of the photonic IC.

As shown in block 606, the method 600 may include securing a second connector to the receptacle using a second adhesive while the photonic IC is mechanically connected to a product printed circuit board. In some embodiments, the method 600 may include after securing the receptacle to the photonic IC using the first adhesive and before securing the second connector to the receptacle, performing a flip-chip and reflow process on the photonic IC to mechanically and electrically connect the photonic IC to a package substrate (e.g., similar to the flip-chip and reflow process 540 as shown and described herein with respect to FIG. 5). Additionally, or alternatively, the method 600 may include, after performing the clip-chip and reflow process, performing a ball-grid-array reflow process (e.g., similar to the ball-grid-array reflow process 560 as shown and described herein with respect to FIG. 5) to mechanically and electrically connect the package substrate to the product printed circuit board. In some embodiments, the method 600 may include, after performing the ball-grid-array reflow process to mechanically and electrically connect the package substrate to the product printed circuit board, securing the second connector to the receptacle using the second adhesive such that the second connector may be held fixed with respect to the receptacle. Additionally, or alternatively, the first adhesive may be the same type of adhesive as the second adhesive. Further, the first adhesive may not be the same type of adhesive as the second adhesive.

Method 600 may include additional embodiments, such as any single embodiment or any combination of embodiments described herein. Although FIG. 6 shows example blocks of method 600, in some embodiments, method 600 may include additional blocks, fewer blocks, different blocks, or differently arranged blocks than those depicted in FIG. 6. Additionally, or alternatively, two or more of the blocks of method 600 may be performed in parallel.

By using a connector that is detachable from a receptacle, active alignment of the receptacle with respect to an optical window of a photonic IC may be performed and tested before the photonic IC is mechanically connected to a package substrate and/or a product PCB, that is, at the die level of assembly, rather than the device level of assembly. Being able to test the alignment at the die level allows for misalignments to be detected early in the assembly process such that, if misaligned, only the photonic IC and the receptacle are disposed of, rather than the entire device (e.g., including the package substrate, the product PCB, and/or the like).

Furthermore, such methods permit testing of the package substrate before assembly of the electronic module. Performing active alignment carly in the assembly process eliminates the need for accurate assembly at a stage in the device assembly process where assembly accuracy is conventionally not required, which reduces the likelihood of an assembly error. Additionally, the height of such a package is suitable for OSFP transceivers.

Although FIG. 6 shows example steps of the method, in some embodiments, the method may include additional steps, fewer steps, different steps, or differently arranged steps than those depicted in FIG. 6.

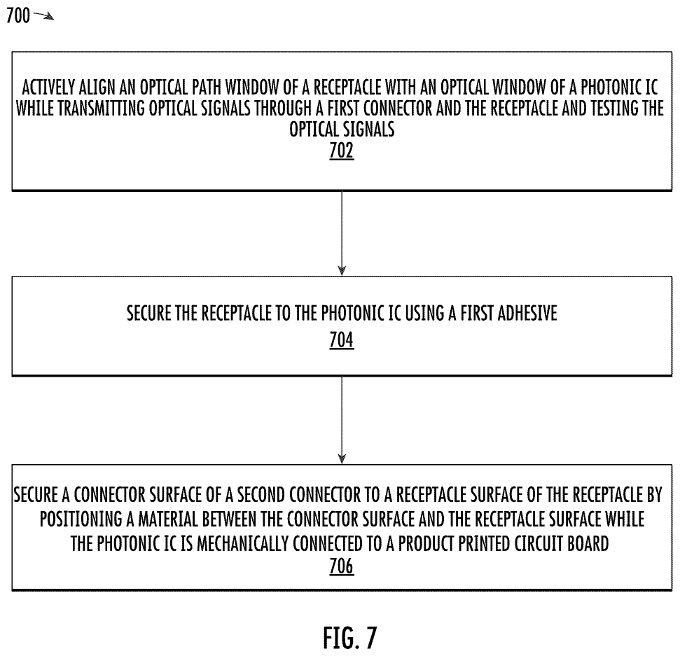

FIG. 7 is a flowchart illustrating a method 700 of assembling a connector for a photonic integrated circuit, in accordance with an embodiment of the disclosure. In some embodiments, the method 700 and/or steps described herein with respect to the method 700 may be performed in conjunction with and/or as one or more steps of the method 500 described herein with respect to FIG. 5.

As shown in block 702, the method 700 may include actively aligning an optical path window of a receptacle with an optical window of a photonic IC while transmitting optical signals through a first connector and the receptacle and testing the optical signals (e.g., similar to step 520 as shown and described herein with respect to FIG. 5). In some embodiments, actively aligning an optical path window of a receptacle with an optical window of a photonic IC may cause optical signals to be accurately transmitted through an electronic device. Further, the first connector may include an optical fiber and an MPO transmitting an optical signal to the first connector. In some embodiments, the receptacle, the photonic IC, and the first connector may be similar to the receptacle, the photonic IC, and the golden connector as shown and described herein with respect to FIG. 5.

As shown in block 704, the method 700 may include securing the receptacle to the photonic IC using a first adhesive. For example, after actively aligning the optical path window of the receptacle with the optical window of the photonic IC, the method 700 may include securing the receptacle to the photonic IC using an adhesive such that the receptacle may be held fixed with respect to the photonic IC. In some embodiments, the optical path window of the receptacle may remain optically aligned with the optical window of the photonic IC.

As shown in block 706, the method 700 may include securing a connector surface of a second connector to a receptacle surface of the receptacle by positioning a material between the connector surface and the receptacle surface while the photonic IC is mechanically connected to a product printed circuit board. In some embodiments, the method 700 may include after securing the receptacle to the photonic IC using the first adhesive and before securing the connector surface of a second connector to the receptacle surface, performing a flip-chip and reflow process on the photonic IC to mechanically and electrically connect the photonic IC to a package substrate (e.g., similar to the flip-chip and reflow process 540 as shown and described herein with respect to FIG. 5). Additionally, or alternatively, the method 700 may include, after performing the clip-chip and reflow process, performing a ball-grid-array reflow process (e.g., similar to the ball-grid-array reflow process 360 as shown and described herein with respect to FIG. 5) to mechanically and electrically connect the package substrate to the product printed circuit board. In some embodiments, the method 700 may include, after performing the ball-grid-array reflow process to mechanically and electrically connect the package substrate to the product printed circuit board, securing the connector surface of the second connector to the receptacle surface by positioning a material between the connector surface and the receptacle surface such that the second connector may be held fixed with respect to the receptacle. Additionally, or alternatively the method 700 may include, after performing the flip-chip and reflow process, testing optical performance and electrical performance (e.g., transmitting optical and/or electrical signals to the IC to ensure precise and/or accurate transmission of the optical and/or electrical signal) of the wafer.

Method 700 may include additional embodiments, such as any single embodiment or any combination of embodiments described herein. Although FIG. 7 shows example blocks of method 700, in some embodiments, method 700 may include additional blocks, fewer blocks, different blocks, or differently arranged blocks than those depicted in FIG. 7. Additionally, or alternatively, two or more of the blocks of method 700 may be performed in parallel.

By using a connector that is detachable from a receptacle, active alignment of the receptacle with respect to an optical window of a photonic IC may be performed and tested before the photonic IC is mechanically connected to a package substrate and/or a product PCB, that is, at the die level of assembly, rather than the device level of assembly. Being able to test the alignment at the die level allows for misalignments to be detected early in the assembly process such that, if misaligned, only the photonic IC and the receptacle are disposed of, rather than the entire device (e.g., including the package substrate, the product PCB, and/or the like).

Furthermore, such methods permit testing of the package substrate before assembly of the electronic module. Performing active alignment early in the assembly process eliminates the need for accurate assembly at a stage in the device assembly process where assembly accuracy is conventionally not required, which reduces the likelihood of an assembly error. Additionally, the height of such a package is suitable for OSFP transceivers.

Although FIG. 7 shows example steps of the method, in some embodiments, the method may include additional steps, fewer steps, different steps, or differently arranged steps than those depicted in FIG. 7.

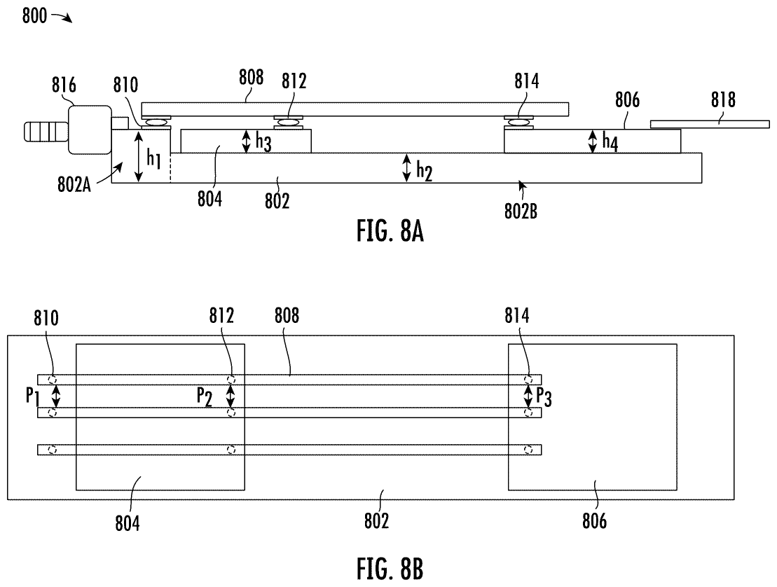

With reference to FIGS. 8A and 8B, a cross-sectional view and a top plan view, respectively, of an optoelectronic component 800 are illustrated. In some embodiments, the optoelectronic component 800 may include a substrate 802. The substrate 802, for example, may be a printed circuit board, a metal carrier, an organic carrier, and/or a ceramic carrier. In some embodiments, the height of the substrate 802 may vary. In this regard, for example, a first portion 802A of the substrate 802 may have a height h1 and a second portion 802B of the substrate 802 may have a height h2. In some embodiments, an electronic integrated circuit 804 may be supported by the substrate 802. The electronic integrated circuit 804 may be any type of electronic integrated circuit. For example, the electronic integrated circuit 804 may be a digital signal processor, a modulator driver, and/or a transimpedance amplifier. In some embodiments, there may be more than one electronic integrated circuit supported by the substrate 802. In some embodiments, the electronic integrated circuit 804 may have a height h3. In some embodiments, the optoelectronic component 800 may support more than one electronic integrated circuit. In some embodiments, a photonic integrated circuit 806 may be supported by the substrate 802. The photonic integrated circuit 806 may be any type of photonic integrated circuit. For example, the photonic integrated circuit 806 may be an electro-optic modulator, a photodiode, a transmitter optical sub assembly and/or a receiver optical sub assembly. In some embodiments, the photonic integrated circuit 806 may comprise graphene. In some embodiments, there may be more than one photonic integrated circuit supported by the substrate 802. In some embodiments, the photonic integrated circuit 806 may have a height h4. In some embodiments, the heights h1, h2, h3, and h4 may be different. For example, depending on the electronic integrated circuit and photonic integrated circuit used, the height h3 may be greater that the height h4, or vice versa.

In some embodiments, the optoelectronic component 800 may include one or more optical fibers 818 connected to the photonic integrated circuit 806. The one or more optical fibers 818 may be configured to connect the optoelectronic component 800 to other optical components and/or devices. In some embodiments, a port 816 may be connected to the substrate 802. The port 816 may be configured to connect the optoelectronic component 800 to other electronic components and/or devices. In some embodiments, the optoelectronic component 800 may be configured to operate at speeds greater than 25 Gb/s.

The optoelectronic component 800 may include a plurality of substrate interconnect connectors 810 disposed on the substrate 802, a plurality of electronic integrated circuit interconnect connectors 812 disposed on the electronic integrated circuit 804, and a plurality of photonic integrated circuit interconnect connectors 814 disposed on the photonic integrated circuit 806. The plurality of substrate interconnect connectors 810, the plurality of electronic integrated circuit interconnect connectors 812, and the plurality of photonic integrated circuit interconnect connectors 814 may comprise any conductive material (e.g., conductive glue and/or solder). In some embodiments, the plurality of substrate interconnect connectors 810, the plurality of electronic integrated circuit interconnect connectors 812, and the plurality of photonic integrated circuit interconnect connectors 814 may be flexible. In other words, in some embodiments, the plurality of substrate interconnect connectors 810, the plurality of electronic integrated circuit interconnect connectors 812, and the plurality of photonic integrated circuit interconnect connectors 814 may be manipulated such that each may be capable of taking various shapes. In some embodiments, the plurality of substrate interconnect connectors 810 may have a pitch p1, the plurality of electronic integrated circuit interconnect connectors 812 may have a pitch p2, and the plurality of photonic integrated circuit interconnect connectors 814 may have a pitch p3. The pitch may refer to the distance between each of the plurality of interconnect connectors. In some embodiments, the pitch p1, pitch p2, pitch p3, may be different. For example, the pitch p2 of the plurality of electronic integrated circuit interconnect connectors 812 may be 1.25 mm while the pitch p3 of the plurality of photonic integrated circuits may be 1.5 mm.

In some embodiments, the optoelectronic component 800 may include a first plurality of cable connectors 808. In some embodiments, each of the first plurality of cable connectors 808 may be connected to and in communication with the substrate 802, the electronic integrated circuit 804, and the photonic integrated circuit 806 via respective interconnect connectors. In other words, the first plurality of cable connectors 808 may be connected to and in communication with the substrate 802 via the plurality of substrate interconnect connectors 810, the electronic integrated circuit 804 via the plurality of electronic integrated circuit interconnect connectors 812, and the photonic integrated circuit 806 via the plurality of photonic integrated circuit interconnect connectors 814. As such, the first plurality of cable connectors 808 may be used to facilitate communication between the substrate 802, the electronic integrated circuit 804, and the photonic integrated circuit 806.

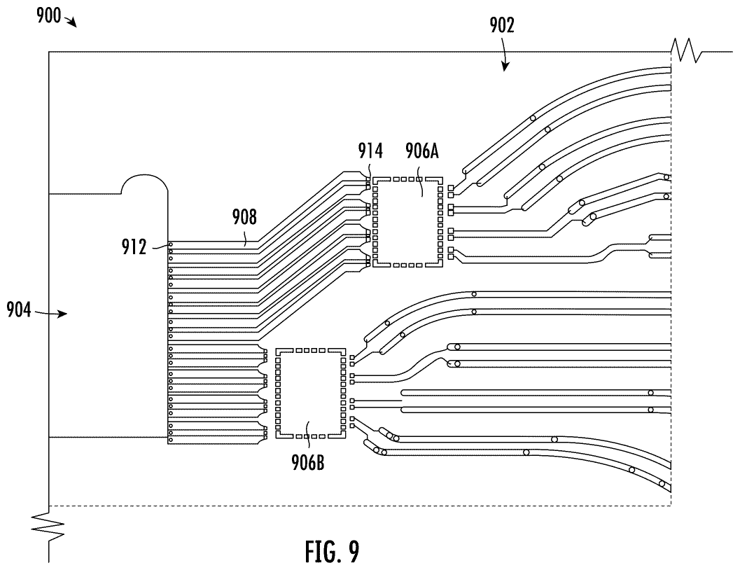

In some embodiments, the first plurality of cable connectors 808 may define a first layout. In some embodiments, the first layout may define the overall connectivity of the optoelectronic component 800. For example, with reference to FIG. 9, the connectivity defined by the first layout in the illustrated example is such that an electronic integrated circuit 904 is connected to a first photonic integrated circuit 906A and a second photonic integrated circuit 906B via cable connectors 908. In some embodiments, the first plurality of cable connectors 808 may be interchangeable with other pluralities of cable connectors that define different layouts. The different layouts may alter the overall connectivity of the optoelectronic component 800. For example, the first plurality of cable connectors 808 may be interchangeable with a second plurality of cable connectors that define a second layout which modifies the overall connectivity of the optoelectronic component 800. In this way, the optoelectronic component 800 may be easily modified to obtain desired capabilities by interchanging cable connectors.

In some embodiments, the first plurality of cable connectors 808 may be flexible. This may help ensure that the first plurality of cable connectors 808 may be used with a variety of substrates, electronic integrated circuits, and photonic integrated circuits. For example, the substrate, electronic integrated circuit, and/or photonic integrated circuit may be from different manufactures, may be a different type of integrated circuit or substrate, and/or may have different capabilities. For example, the substrate 802, electronic integrated circuit 804, and the photonic integrated circuit 106 may have different heights (e.g., height h3 of the electronic integrated circuit 804 may be greater than height h4 of the photonic integrated circuit 806). The flexibility of the first plurality of cable connectors 808 enables the first plurality of cable connectors 808 to bend as needed, such that components of the optoelectronic component 800 with different heights may be accommodated and connections may be made without any modifications to the configuration of the optoelectronic component 800 itself. Additionally, the flexibility of the first plurality of cable connectors 808 may enable the first plurality of cable connectors 108 to be used with a variety of substrates, electronic integrated circuits, and photonic integrated circuits that have interconnect connectors with different pitches. For example, if the pitch p2 of the plurality of electronic integrated circuit interconnect connectors 812 is less than the pitch p3 of the plurality of photonic integrated circuit interconnect connectors 814, the first plurality of cable connectors 808 may bend to account for the differences in pitch and connect the electronic integrated circuit 804 to the photonic integrated circuit 806.

With reference to FIG. 9, a portion of an example optoelectronic component 900 is illustrated. For example, the example optoelectronic component 900 may be part of a 1.6 Tb/s demonstrator. The example optoelectronic component 900 may include a substrate 902, an electronic integrated circuit 904 supported by the substrate 902, a first photonic integrated circuit 906A supported by the substrate 902, and a second photonic integrated circuit 906B supported by the substrate 902. The example optoelectronic component 900 may include a plurality of electronic integrated circuit interconnect connectors 912 disposed on the electronic integrated circuit 904 and a plurality of photonic integrated circuit interconnect connectors 914 disposed on the first photonic integrated circuit 906A and the second photonic integrated circuit 906B. The electronic integrated circuit 904 may be connected to and in communication with the first photonic integrated circuit 906A and the second photonic integrated circuit 906 B via a plurality of cable connectors 908. In the example optoelectronic component 900, the electronic integrated circuit 904 and the first photonic integrated circuit 906A are situated on the substrate 902 such that the plurality of electronic integrated circuit interconnect connectors 912 and the plurality of photonic integrated circuit interconnect connectors 914 disposed on the first photonic integrated circuit 906A are not aligned with each other (e.g., one is not disposed directly opposite to the other). In such a situation, the flexibility of the plurality of cable connectors 908 facilitating communication between the electronic integrated circuit 904 and the first photonic integrated circuit 906A may allow the electronic integrated circuit 904 and the first photonic integrated circuit 906A to be connected through manipulation of the cable connectors to accommodate the misaligned locations.

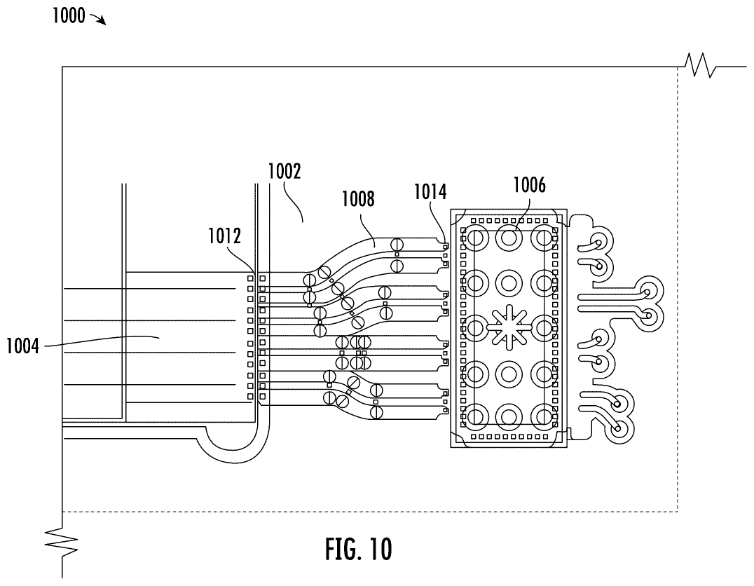

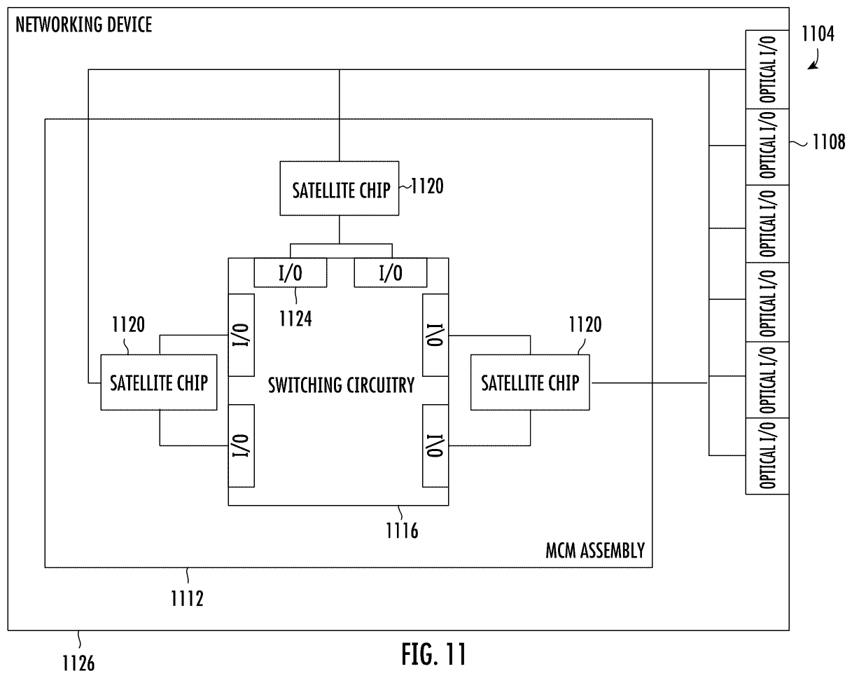

With reference to FIG. 10, another example optoelectronic component 1000 is illustrated. For example, the example optoelectronic component 1000 may be part of an octal small form factor pluggable (OSFP) transceiver. The example optoelectronic component 1000 includes a substrate 1002, an electronic integrated circuit 1004 supported by the substrate 1002, and a photonic integrated circuit 1006 supported by the substrate 1002. The example optoelectronic component 1000 may include a plurality of electronic integrated circuit interconnect connectors 1012 disposed on the electronic integrated circuit 1004 and a plurality of photonic integrated circuit interconnect connectors 1014 disposed on the photonic integrated circuit 1006. The electronic integrated circuit 1004 may be connected to and in communication with the photonic integrated circuit 1006 via a plurality of cable connectors 1008. In the example optoelectronic component 1000, the pitch of the plurality of the electronic integrated circuit interconnect connectors 1012 and the plurality of photonic integrated circuit interconnect connectors 1014 is different. In this case, the flexibility of the plurality of cable connectors 1008 facilitating communication between the electronic integrated circuit 1004 and the photonic integrated circuit 1006 may be such that the electronic integrated circuit 1004 and the photonic integrated circuit 1006 can be connected despite the differences in pitch, such as through bending or other reshaping of the cable connectors to accommodate the differences.

Co-packaging may refer to the close integration of different electrical and/or optoelectronic chips in the same package. The different chips that constitute the co-packaged system are assembled on a single substrate in what is typically called the MCM assembly 1112. The MCM assembly 1112 may include switching circuitry 1116 surrounded by peripheral or satellite chips 1120. Various example configurations of an MCM assembly 1112 will be described in further detail herein. In some embodiments, the switching circuitry 1116 and surrounding satellite chips 1120 are all mounted on a common substrate, although such a configuration is not required. The MCM assembly 1112 may be provided in a larger housing of a networking device 1126, positioned behind the front panel 1104. The switching circuitry 1116 may include one or more core digital Application Specific Integrated Circuits (ASICs), CPUs, GPUs, microprocessors, FPGAs, combinations thereof, and the like. The switching circuitry 1116 may include a number of input ports and/or output ports 1128. The Input/Output (I/O) ports 1124 may include electrical ports and/or optical ports. Additionally, the switching circuitry 1116 may include a combination of electrical blocks and optical blocks. The electrical blocks of the switching circuitry 1116 may include a number of electrical switches that are configured to route signals in an electrical domain. The optical blocks of the switching circuitry 1116 may include a number of optical components that are configured to generate, detect, and route signals in an optical domain. The MCM assembly 1112, in some embodiments, may concern or include multiple satellite chips 1120 that are assembled on the same substrate as the switching circuitry 1116. In some embodiments, a configuration of the optical block(s) and a configuration of the electrical block(s) depends (e.g., is based on) on the number of optical ports in the I/O ports 1124.

As will be appreciated by one of ordinary skill in the art in view of this disclosure, the present disclosure may include and/or be embodied as an apparatus (including, for example, a system, a machine, a device, and/or the like), as a method (including, for example, a manufacturing method, a robot-implemented process, and/or the like), or as any combination of the foregoing.

Although many embodiments of the present disclosure have just been described above, the present disclosure may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present disclosure described and/or contemplated herein may be included in any of the other embodiments of the present disclosure described and/or contemplated herein, and/or vice versa.

While certain exemplary embodiments have been described and shown in the accompanying drawings, it is to be understood that such embodiments are merely illustrative of and not restrictive on the broad disclosure, and that this disclosure is not limited to the specific constructions and arrangements shown and described, since various other changes, combinations, omissions, modifications, and substitutions, in addition to those set forth in the above paragraphs, are possible. Those skilled in the art will appreciate that various adaptations, modifications, and combinations of the just described embodiments may be configured without departing from the scope and spirit of the disclosure. For example, devices, modules, components, and/or elements shown in the figures are not necessarily drawn to scale and may vary from that shown without departing from the scope and spirit of the disclosure. Therefore, it is to be understood that, within the scope of the appended claims, the disclosure may be practiced other than as specifically described herein.

What is claimed is:

1. A method of assembling a connector for a photonic integrated circuit (IC), the method comprising:
actively aligning an optical path window of a receptacle with an optical window of a photonic IC while transmitting optical signals through a first connector and the receptacle and testing the optical signals;
securing the receptacle to the photonic IC using a first adhesive; and
securing a second connector to the receptacle using a second adhesive while the photonic IC is mechanically connected to a product printed circuit board.

2. The method of claim 1, comprising, after securing the receptacle to the photonic IC using the first adhesive and before securing the second connector to the receptacle, performing a flip-chip and reflow process on the photonic IC to mechanically and electrically connect the photonic IC to a package substrate.

3. The method of claim 2, comprising, after performing the flip-chip and reflow process, performing a ball-grid-array reflow process to mechanically and electrically connect the package substrate to the product printed circuit board.

4. An electronic module, comprising:
a receptacle comprising an optical path window, wherein the receptacle is secured to a photonic integrated circuit (IC) having an optical window using an adhesive, and wherein the optical path window is actively aligned with the optical window; and
a connector secured to the receptacle.

5. The electronic module of claim 4, wherein the optical path window comprises adhesive bleeding stoppers configured to prevent adhesive from entering the optical path.

6. The electronic module of claim 4, wherein the receptacle comprises one or more alignment features for aligning the connector with the photonic IC.

7. The electronic module of claim 6, wherein the receptacle comprises one or more alignment features for aligning the receptacle with the photonic IC.

8. The electronic module of claim 7, wherein the receptacle comprises one or more alignment features for aligning the receptacle with the connector.

9. An optical device comprising:
a photonic integrated circuit (IC) comprising a first photonic IC surface and a second photonic IC surface;
an adhesive layer disposed on a region of the second photonic IC surface;
a receptacle comprising a first receptacle surface and a second receptacle surface, wherein the first receptacle surface is disposed on the region of the second photonic IC surface comprising the adhesive layer, and wherein the first receptacle surface is adhered to the second photonic IC surface; and
a connector comprising a first connector surface and a second connector surface, wherein the first connector surface is disposed on the second receptacle surface, wherein a material is disposed between the first connector surface and the second receptacle surface such that the first connector surface is adhered to the second receptacle surface.

10. The optical device of claim 9, wherein the first photonic IC surface is disposed on a second surface of a package substrate.

11. The optical device of claim 10, wherein a first surface of the package substrate is mechanically and electrically connected to a printed circuit board.

12. The optical device of claim 10, wherein the photonic IC comprises an optical window, and wherein the receptacle comprises an optical path window.

13. The optical device of claim 12, wherein the optical path window and the optical window are actively aligned.

14. The optical device of claim 9, wherein the receptacle comprises a plurality of alignment features.
